(19) United States
(12) Patent Application Publication
(10) Pub. No.: US 2007/0264399 A1
(43) Pub. Date: Nov. 15, 2007

(54) Manufacture of Chocolate Products

(76) Inventors: Nathaniel Gordon Hilary Lucas, Arundel (AU); John Wesley Taylor, Burleigh Heads (AU)

Correspondence Address: HUDAK, SHUNK & FARINE, CO., L.P.A., 2020 FRONT STREET, SUITE 307, CUYAHOGA FALLS, OH, 44221, US

(21) Appl. No.: 10/574,255

(22) PCT Filed: Sep. 28, 2004
(86) PCT No.: PCT/AU04/01330

§ 371 Date: Mar. 5, 2007

(30) Foreign Application Priority Data
Oct. 1, 2003 (AU) 2003905345
Oct. 1, 2003 (AU) 2003905344

(51) Int. Cl. A23G 1/22

(52) U.S. Cl. 426/515; 264/219; 425/123

(57) ABSTRACT

A mould plate former (10) is produced where former shapes (13) are located on a former plate (10a)by a template (20). A mould plate (60) with recesses (61) aligned with engraved images (17) on a graphics plate, is produced by placing a mixed solution (34) of a silicone compound (30) and hardener (33) in the former (10) after any air bubbles in the solution (34) have been removed under vacuum. The mould plate (60) is allowed to initially cure, is trimmed and then post-cured (e.g., in a curing oven (80)). The mould plate (60) is used to manufacture chocolates of two (or more) colours with a thin design or at least one colour on a chocolate of another colour.

### BACKGROUND OF THE INVENTION

1. Field of the Invention

THIS INVENTION relates to a method of manufacture of chocolate products.

The invention also relates to a method of manufacture for moulds for chocolate products.

The invention is particularly suitable for, but not limited to, the manufacture of moulds for the production of chocolate products having thin raised design (s) thereon in different colour(s) than the rest of the chocolate products; and for the chocolate products produced in such moulds.

2. Prior Art

International Publications WO 97/39636 (=PCT/AU97/00245) and WO 02/15707 (=PCT/AU01/01067) disclose respective methods for the manufacture of chocolate products with thin raised design(s), of at least one different colour chocolate thereon.

The manufacture of the second mould plate, the cavities in which must accurately register with the engraved designs in the first mould plate, has been difficult.

Whilst the use of polyurethane or silicone rubber for the second mould plates is known, there has been difficulty in accurate, repetitive manufacture of the second mould plates.

### SUMMARY OF THE PRESENT INVENTION

It is an object of the present invention to provide a method of manufacturing the mould plates to a high degree of accuracy and/or repeatability.

It is a preferred object to provide a method for producing a former for the mould plates.

It is a further preferred object to provide a method which is commercially economic.

It is a further preferred object of the present invention to provide a method of manufacturing the chocolate product with a thin raised design thereon to a high degree of accuracy and/or repeatability.

Other preferred objects will become apparent from the following description.

In one aspect, the present invention resides in a method of manufacturing a former for a mould plate for chocolate products, including the steps of:

assembling a former plate, having a planar surface bounded by a border corresponding to the external dimensions of the mould plate;

producing a plurality of former shapes, corresponding to the recesses to be formed in the mould plate;

locating the former shapes in a template operable to locate the former shapes on the former plate;

applying adhesive to the former shapes; and

locating the former shapes on the former plate, using the template, to fix the former shapes to the former plate.

Preferably, the template has holes, operable to receive at least a portion of the former shapes, the holes being aligned with engraved or otherwise formed images on a graphics plate to which the mould plate is to be associated.

Preferably, the images on the graphics plate are formed by a laser engraver and are located thereon at spacings determined by a template layout programmed in computer software which controls the laser engraver.

The mould plate may be profiled to form a border around the engraved image.

In a second aspect, the present invention resides in manufacturing a mould plate for chocolate products including the steps of:

mixing a silicone rubber compound with a hardener to form a solution;

applying a vacuum to the solution to remove at least the majority of the air bubbles in the solution;

pouring the solution into a mould former and allowing the solution to settle;

applying a clamping pressure to the mould assembly and allowing the silicone rubber to at least initially cure; and

allowing the rubber to post cure before use.

Preferably, the solution is thoroughly mixed; and preferably, a coloured hardener is used to see when mixing is complete.

Preferably, the mould former is manufactured by the method of the first aspect.

When the solution is poured into the mould former, filtered dry air may be blown onto the surface to remove air bubbles on the surface and agitate and settle the solution around the shapes in the former.

A flexible divider may be applied to the top surface of the former and rolled with a roller to work any air pockets out of the mould plate and cause excess solution to be excluded from the former.

Preferably, the initial curing is for 24 hours.

Preferably, the edges of the mould plate are trimmed to remove any excess rubber.

The post curing may be at room temperature, eg., for 7-10 days, or in a curing oven, eg., at 200° C. for approximately 2 hours.

In a third aspect, the present invention resides in a method of manufacturing chocolates with a thin design of at least one other colour thereon, the method including the steps of:

engraving a plurality of images, corresponding to the design, on a graphics plate at preselected locations;

producing a mould plate former by the method of the first aspect;

producing a rubber mould plate using the mould plate former by placing a rubber solution in the mould plate former and allowing the solution to cure;

applying chocolate of at least a first colour to the graphics plate to fill the engraved image thereon, to form the design, and removing any excess chocolate;

locating the mould plate on the graphics plate with the recesses in the mould plate in register with the designs of the at least first colour chocolate;

filling the recesses with another colour chocolate;

allowing the chocolate to set; and

removing the final chocolates from the mould plate.

In a fourth aspect, the present invention relates to chocolates with a thin design thereon made by the method of the third aspect.

### BRIEF DESCRIPTION OF THE DRAWINGS

To enable the invention to be fully understood, a preferred embodiment will now be described with reference to the accompanying drawings, in which:

FIG. 1 shows the assembly of the former plate;

FIGS. 2(a) to (c) show the engraving process for the former shapes;

FIG. 3 shows the original image, engraved images and final results for a thin design on different coloured chocolate bases;

FIG. 4 shows the assembly of the former for the mould plate;

FIG. 5 shows the completed former for the rubber mould plate; and

FIGS. 6 to 15 inclusive show the steps in making the mould plates, where FIGS. 9 and 9(A) and FIGS. 10 and 10(A) illustrate respectively single and multiple mould processing steps.

### DETAILED DESCRIPTION OF THE PREFERRED EMBODIMENTS

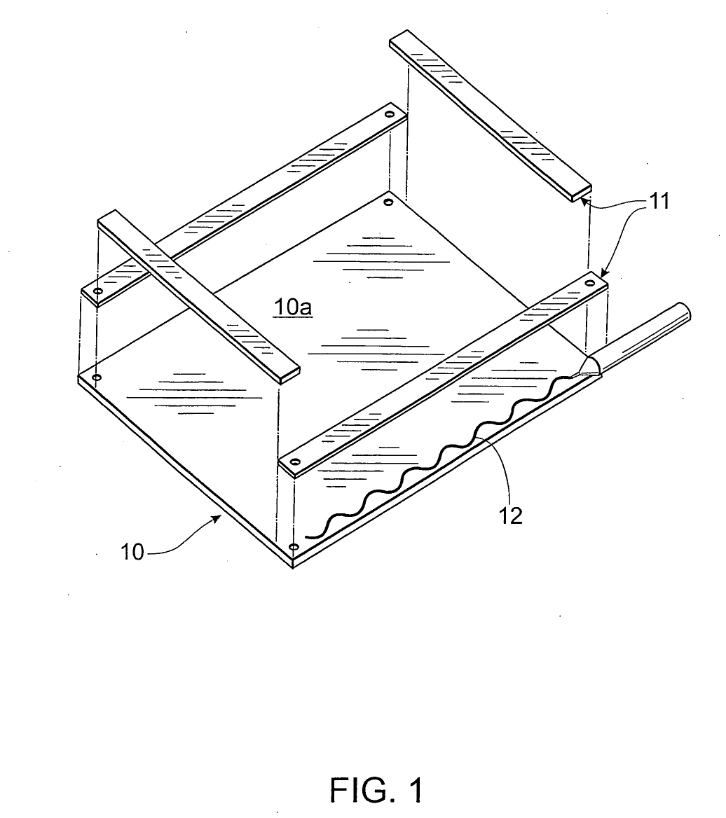

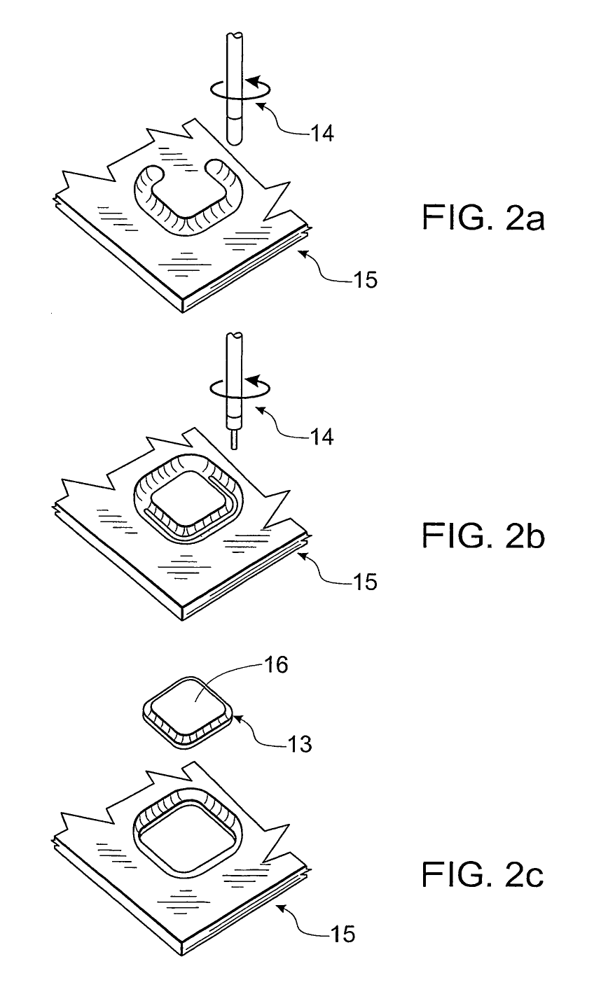

I. Basic Process for Making Rubber Mould Formers (FIGS. 1 to 5)

It is important to remember when selecting materials for the formers for the silicone rubber moulds that they must have a good natural “release factor”, as no release agents can be used within the former when moulding.

The formers are made up in two basic parts:

1. The former plate (assembled base plate and edges);

2. The former shapes (the shapes positioned within the former plate).

1. Former Plate (FIG. 1)
For construction of the former 10, a Shenkolite (trade mark) plastic is preferably used. The material is tough, available in various accurate thicknesses and needs no surface preparation, apart from the edges. This results in an accurate mould with a high degree of surface finish that requires no additional work. It is readily available, cut to size and is easily assembled.
An additional, but high preferable, benefit of Shenkolite (trade mark), is a lack of adhesion (high release factor) with the silicone rubber moulding compound, thus allowing ease of mould removal and minimal risk of damage.
By using a template cut to the correct rubber mould dimensions, the former 10 is easy to accurately assemble, and cost effective to produce.
Shenkolite strips 11 are then placed onto the former plate 10a using “Loctite” (trade mark) glue 12 to the exact size of the rubber mould plate required.

2. Former Shapes (13)
The former shapes 13 are also made from Shenkolite (trade mark) plastic.
Shenkolite plastic blocks are machined from a sheet 15 to form the initial former shape. Machining is accurate when using an engraver 14 allowing mass-production and mirror-image consistency.
Engraving the shapes 13 allows for variation in design, ie., scalloped or bevelled edges 16.
In the case of smaller designed shapes 13, a laser is used to straight-cut Shenkolite plastic similar to the template allowing for a more rigid mould.

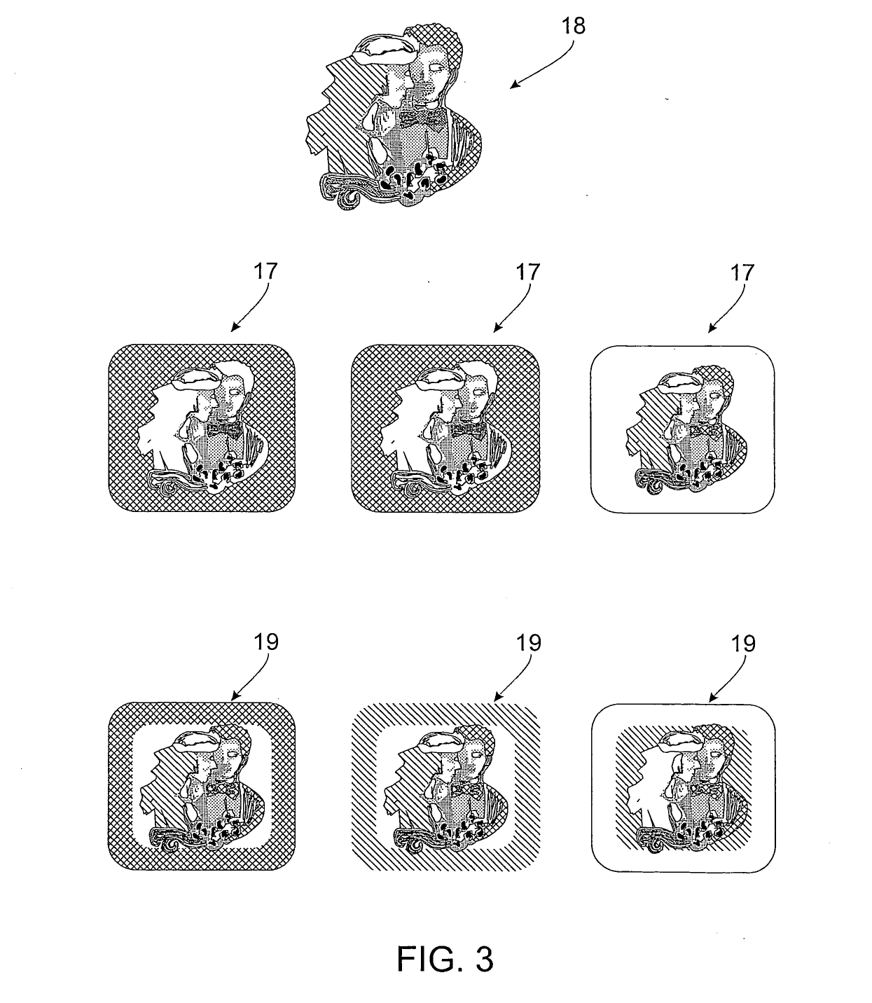

3. Engraved Images (FIG. 3)
The former shapes 13 are used to form the recesses in the mould plate which will be in register with the images 17 engraved on the graphics plate, eg., by a laser engraver sold under the “T ROTEC” trade mark.
FIG. 3 illustrates the original photograph image 18 from which the thin design is to reproduce; the respective images 17 engraved on a graphics plate where the body of the chocolate is dark, milk or white chocolate; and the resulting chocolates 19 produced by the method of the present invention.

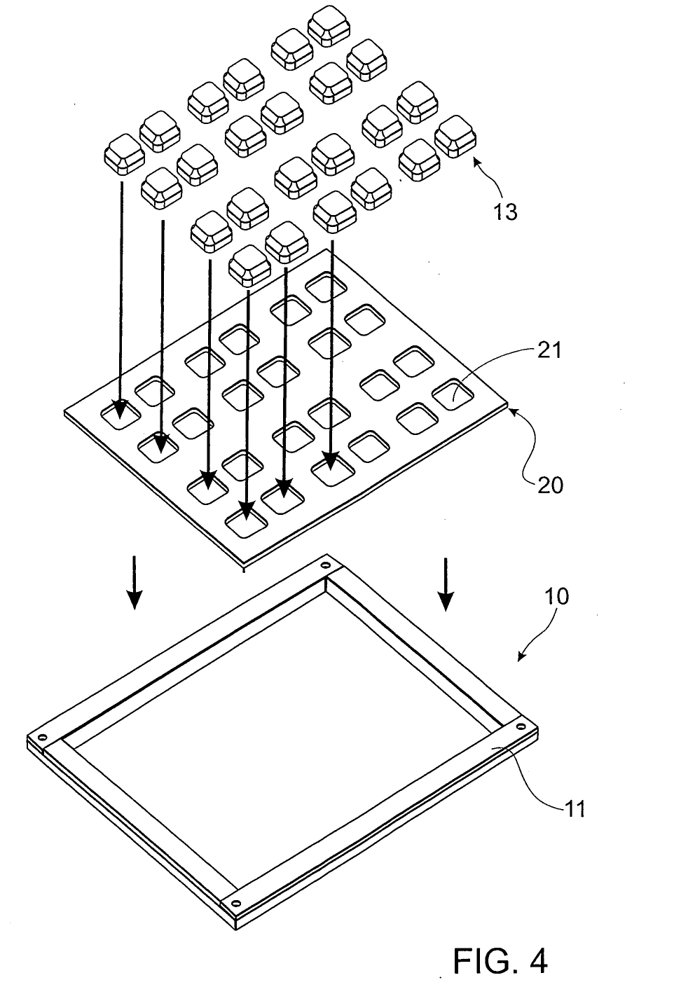

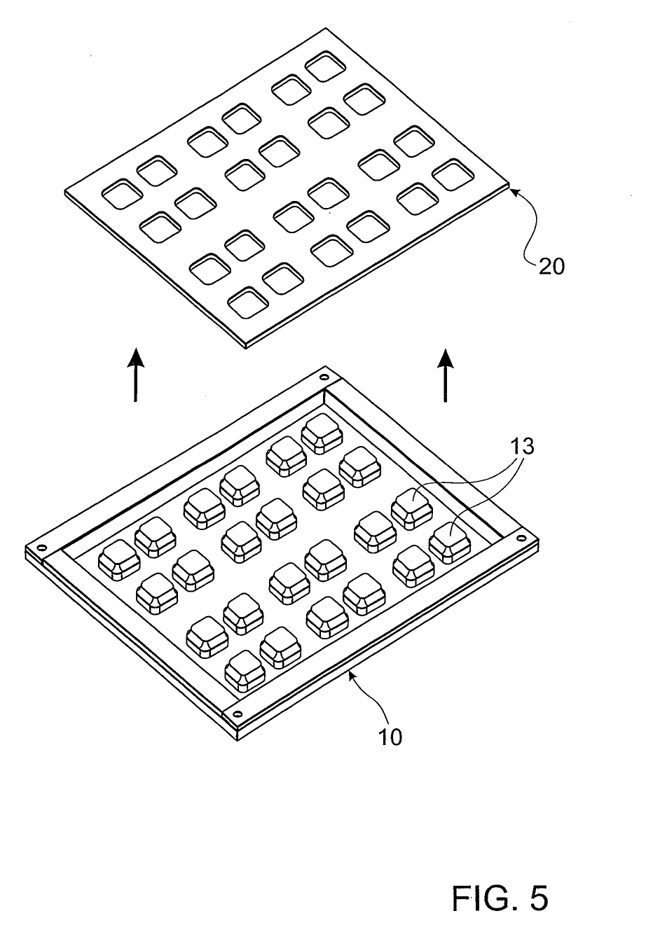

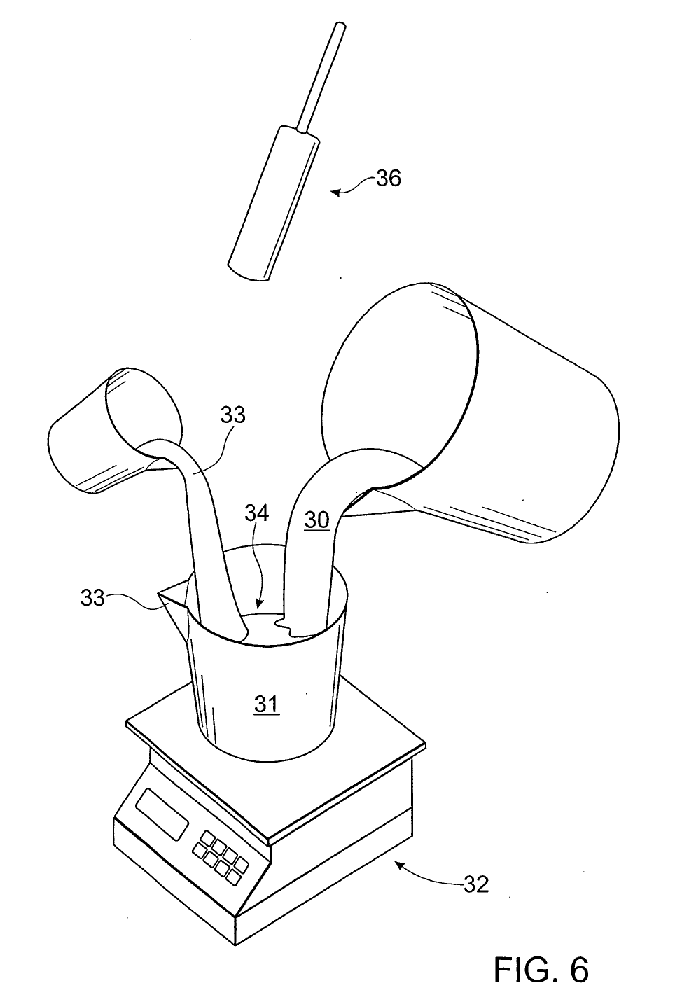

4. Former Assembly (FIGS. 4 and 5)
For accuracy and ease of pattern assembly, a “template” 20 is utilised to position each former shape 13 within the former plate 10. This ensures accuracy for positioning the former shapes 13 in relation to each other, the former plate 10A and ultimately the graphics plate.
“Loctite” (trade mark) glue is a good adhesive as only a very thin layer is required leaving no gaps when assembling the former plates or the former shapes. Because the glue sets almost instantly, using a template 20 will greatly reduce the risk of error.
The holes 21 in the template 20, which receive the former shapes 13, are accurately cut out by a laser cutter to ensure that the recesses in the mould plate will accurately register with the engraved images on the graphics plate.
When the former 10 is completed (see FIG. 5), the silicone rubber mould plate 60 can be produced.

II. Process for Making Mould Plates (FIGS. 6 to 15)

The moulding process is divided into 10 basic stages:
A—Preparation
B—Measuring
C—Mixing
D—Vacuuming
E—Pouring/Settling
F—Pressing/Clamping
G—Curing
H—Trimming
I—Post Curing
J—Clean Up

A—Preparation

1. The entire work area must be clean and dust free with stainless steel work benches.

2. The former plate 10 components must be thoroughly clean and dust free. Note: Any product that is not “food grade” shall not be used to clean, or be allowed to come into contact with any surface or items that are used with the “Elastosil M 4642 Silicone Rubber” moulding compound (hereinafter called “silicone”). All surfaces must be dry and dust free. The use of filtered dry compressed air is ideal in these circumstances as static in the former causes dust and fibres to cling to the surface.

3. Wax or Vaseline (trade mark) is a good release agent for other surfaces that will come into contact with the compound and will shorten clean-up times.

4. Prior to commencement, all equipment and formers must be set out in the correct order.

B—Measuring (FIG. 6)

The silicone rubber compound 30 is poured into a mixing bucket 31 (on scales 32) in a “weight measured” amount. The correct amount required is determined by the size of the former plate 10.

Note: An allowance is made for a slight excess—this allows for compound that remains in the mixing bucket and on the stirrer, as well as ensuring adequate mixture to fill the former plates 10. The excess is squeezed out during clamping. A small waste will occur but is proven to be essential in forming perfect rubber moulds.

Note: Do not weigh a previous mould and measure out the same amount for a new one.

C—Mixing (FIG. 6)

1. After measuring the silicone rubber compound 30, the hardener 33 is added at ratio of 9% (+1%) of the “weighted” amount. (Hereinafter called “the solution” 34). The 1% tolerance is to allow for carry over during pouring when weighing the hardener 33. Too much hardener 33 will reduce the working time of the mixed solution 34, and can prevent proper curing, or cause a shortfall when using the last of the silicone in the drum. Too little will also prevent proper curing.

Note: When mixing large quantities of the solution 34, it is important that approximately half the hardener 33 is added and well mixed in before adding the remainder. This prevents too much hardener 33 being concentrated at one time causing part of the solution 34 to start to gel.

2. Mixing is crucial—if the solution 34 is not thoroughly mixed, uncured areas may occur within the finished rubber mould. A coloured hardener 33 is highly preferable as it is easy to see when the mixing process is complete. Mixing should only take about 1 minute.
Several items are highly preferable for mixing:
a) Mixing bucket 31—i) must be round and have a flat base; (ii) must fit the vacuum chamber; (iii) must have a pouring spout 35; and (iv) must be of suitable size to contain the “foaming” of the solution 34 while vacuuming.
b) Stirrer 36—i) must be suitably rigid, of a metal or hard plastic type material and be able to reach into the bottom corners of the bucket 31.

3. Once the hardener 33 is added, the solution 34 has a working life of approximately “35 minutes”. After this time, the solution 34 starts to set and the removal of air bubbles and proper forming becomes difficult.
Time must be carefully considered when making varying numbers of multiple moulds. If a shortfall in the solution 34 amount occurs, there is very likely little or no time left to mix and add more solution.

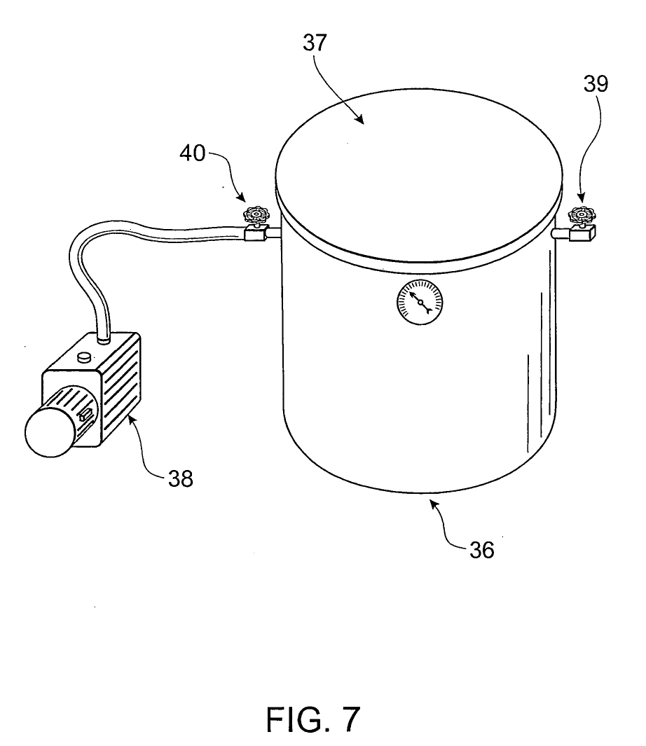

D. Vacuuming (FIG. 7)

Air is introduced into the silicone rubber compound 30 and mixed solution 34 during all stages, from manufacture to packaging to mixing. This must be removed as much as possible prior to pouring into the former 10. Note: Not all air will be removed in the time allowed—this will be addressed during the pouring/setting process.

1. Place the mixing bucket 31 into the vacuum chamber 36 and position the lid 37. It is very important that the lid 37 is positioned accurately on the top of the chamber 36—if it is not and the vacuum dislodges it, the solution 34 will be spoiled.

2. Start the vacuum pump 38 and then close the inlet valve 39. Do not try to start the pump under load.

3. As the vacuum increases, the solution 34 will start to “foam” as the air is drawn out of the mixture. Manual agitation of the vacuum chamber 36 during this period will settle the foaming and prevent overflowing of the bucket 31. It is important that the vacuuming process be watched in the initial stages.

4. Vacuum for approximately 10 minutes, depending on the volume of the solution 34. The solution 34 will foam and settle several times during vacuuming. Experience with use will ultimately give better control and results.

5. Leave the pump 38 running and close the valve 40 from the vacuum chamber 36 to the pump 38. (Leave the pump 38 running with the valve 40 closed until the rubber moulds are poured, this vacates the pump 38.) Slowly open the inlet valve 39 to the chamber 36 and allow the air to bleed back into the chamber 36 until the pressure is neutralised. This must be done slowly or the solution 34 will become aerated and could “explode” within the chamber 36. The solution 34 will settle immediately the inlet valve 39 is opened and all foaming or bubbles will be seen to disappear.

6. Once settled, remove the bucket 31 from the chamber 36, being careful not to allow any dirt or dust, etc., to fall into the solution 34.

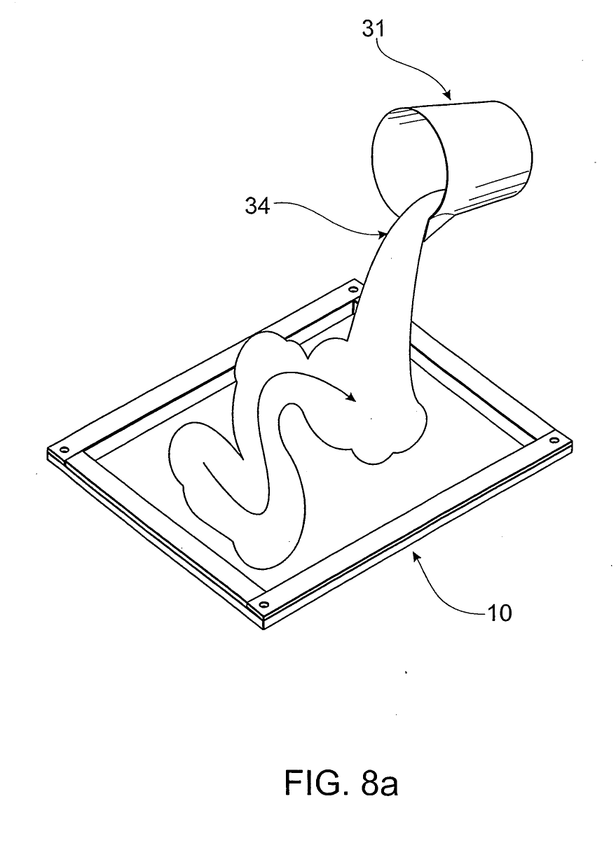

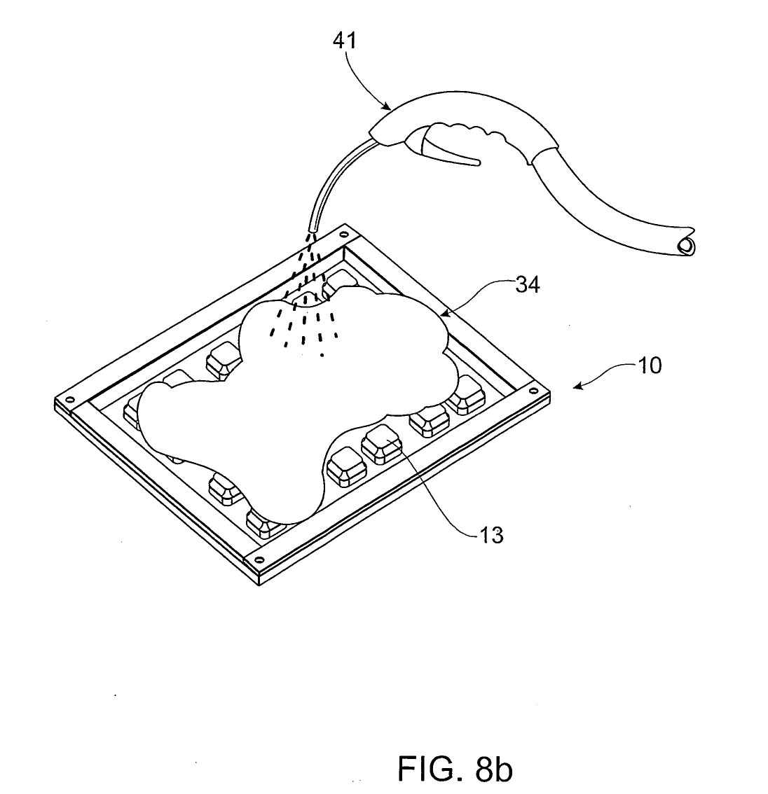

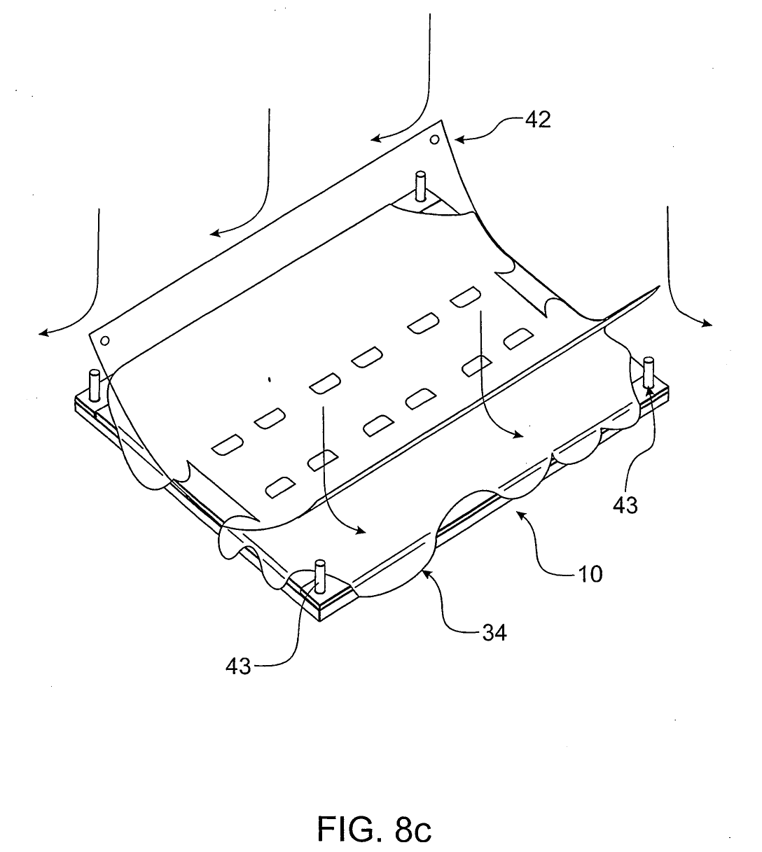

E—Pouring/Settling (FIGS. 8(a)-(c))

During the pouring, it is important to minimise the risk of introducing air back into the solution 34. Hold the bucket 31 approximately 150 mm from the former 10 and slowly and smoothly pour the solution 34 in with one unbroken motion.

1. Beginning with the first of the formers 10, and starting from any corner of the arranged former shapes 13 within the former 10, work in a vertical zig zag (FIG. 8(a)) motion across all of the shapes and gaps between the former shapes until reaching the last shape. Continue back and forth until adequate solution 34 is poured. It is important that all of the former shapes 13 are totally covered. Use a spatula to evenly distribute the solution.

2. Air bubbles will again appear on the surface of the solution 34. Using a low-pressure air gun 41 (filtered dry air, not lubricated) blow across the surface of the solution 34 whenever air bubbles are evident. This process can take several minutes for best results (FIG. 8(b)).

This has several effects:

a) It will remove the air bubbles on the surface.

b) It will agitate and settle the solution 34 around the former shapes 13 and bring other air bubbles to the surface.

Do not use high air pressure as it may aerate the solution 34 or blow it out of the former 10.

3. Allow the solution 34 to settle evenly across the former 10. Gently fold the 1 mm clear polycarbonate divider 42 (FIG. 8(c)) and starting from the centre of the former 10, roll it out toward the edges. Using a 150 mm (approximately) wide roller will aid with the disbursement of the solution 34 and work any air pockets out of the mould. The excess solution 34 will flow out the sides of the former 10 and should be collected and used in the following former. Locate the divider 42 on the locating pins 43.
Repeat the process for the remaining formers 10, scraping the last of the solution 34 out of the bucket 31 into the last former 10. If measured correctly there will be minimal waste. As each former 10 is completed, it is placed into the press 50, the next former 10 is placed on top of the first until all are completed. Clamping bolts are used for alignment.

4. Scrape away any excess solution 34 from around the formers 10, in preparation for pressing.
Some excess solution spillage is unavoidable, so care must be taken to avoid getting any onto clothes or spread around the work area.
Again, it is very important that the solution 34 has not begun to set before pressing.

F—Pressing/Clamping

There are two methods of pressing and clamping:

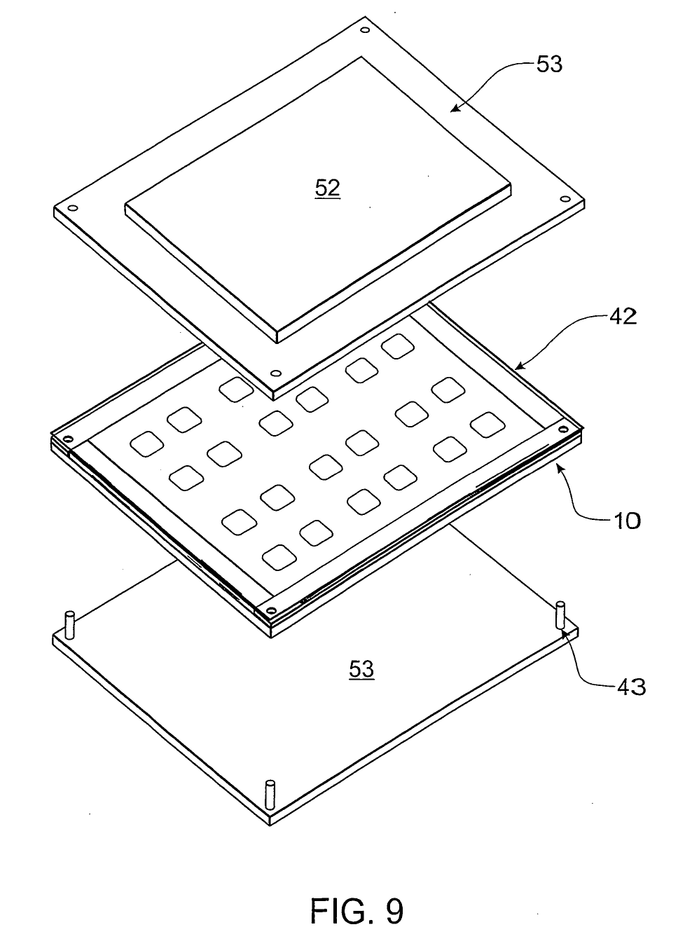

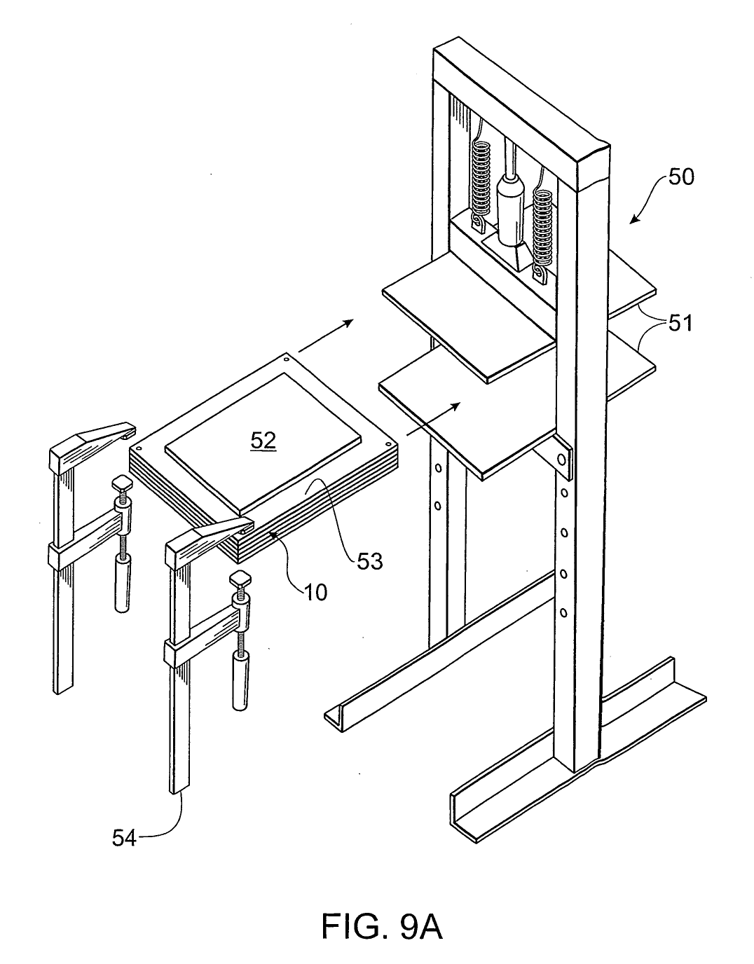

1. A single mould former assembly (FIG. 9).
a) Place the assembled former 10 into a press 50 ensuring that it is square within the press plates 51 to obtain an even pressure (FIG. 9(A)).
b) Place a pressure board 52 on top of the cushion board 53. The pressure board 52 is the same size as the area covered by the formers and is used to concentrate the pressing force in this area.
c) Apply a steady pressure until the former 10 is firmly clamped and large amounts of excess solution have stopped flowing (about 4000 kg is sufficient force). Place 4 “G” clamps 54 (or similar) equally around the former and firmly tighten to compensate, should the press 50 lose pressure during curing.
If they are unavailable, the press plates 51 used in method 2 can be used.

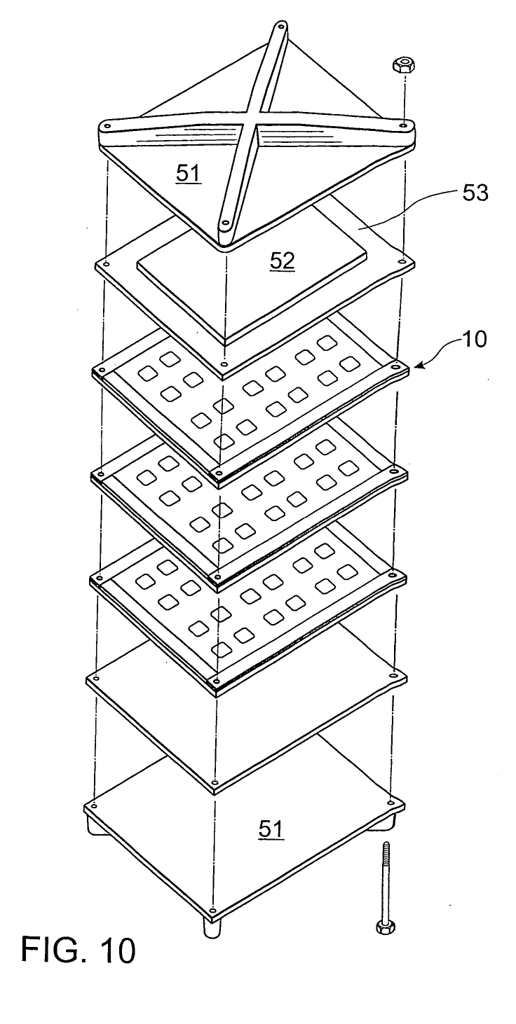

2. A multiple mould former assembly (FIGS. 10 and 10(A)).
Pressing is carried out as per the first method with the exception that the formers 10 are stacked and clamped using press plates 51 which are clamped with bolts 55 after pressing is complete.
A pressure board 52 is only required for the top mould as per the single mould method.
The cushion boards 53 are of a soft material (ie., plywood or plastic), yet rigid enough to spread pressure past the pressure board 52 to the edges of the formers 10. This material is used to prevent fracturing of the Shenkolite formers 10, which may occur when placed under pressure from a metal surface. (Any slight imperfections or grit between the press plates 51 and the formers 10 will be absorbed by the cushion boards 53.)
Care must be taken to ensure the correct length press plate clamping bolts 55 are ready for clamping (dependent on the number of formers used).

G—Curing

1. The initial curing process for the mould plates 60 takes 24 hours before the clamping pressure can be released from the former(s) 10, and the former(s) 10 removed from the press 50 or press plates 51.

2. Peel away any excess cured rubber from around the former(s) 10 and remove the top.

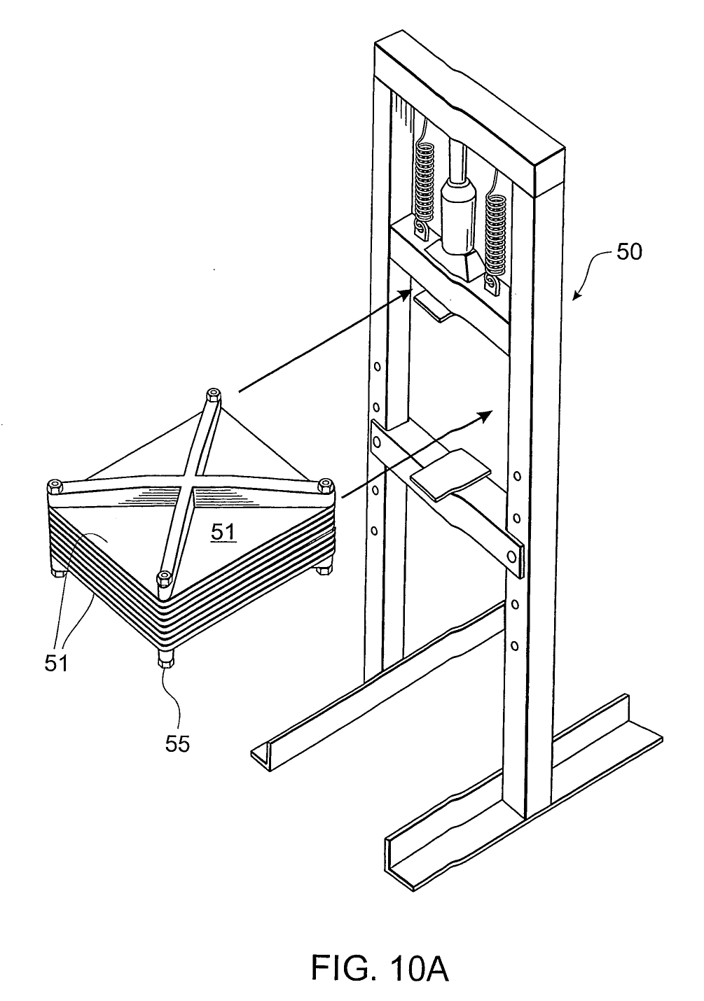

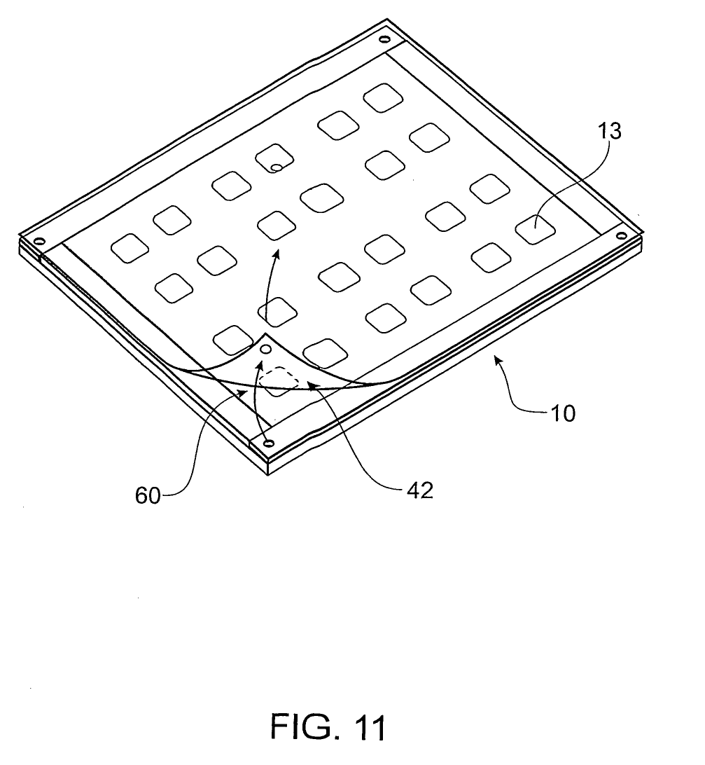

3. Carefully peel the divider 42 off the rubber mould plate 60 starting at one corner and working diagonally across the rubber mould plate (FIG. 11).
The rubber mould plate 60 cannot be removed from the former 10 until initial trimming has been done around the top of the former shapes 13 (see “Trimming”).
By utilising the press plates 51, the mould assembly can be removed from the press 50 when clamped and further moulding can continue, using the same press 50, and additional press plates 51 and formers 10.

H—Trimming

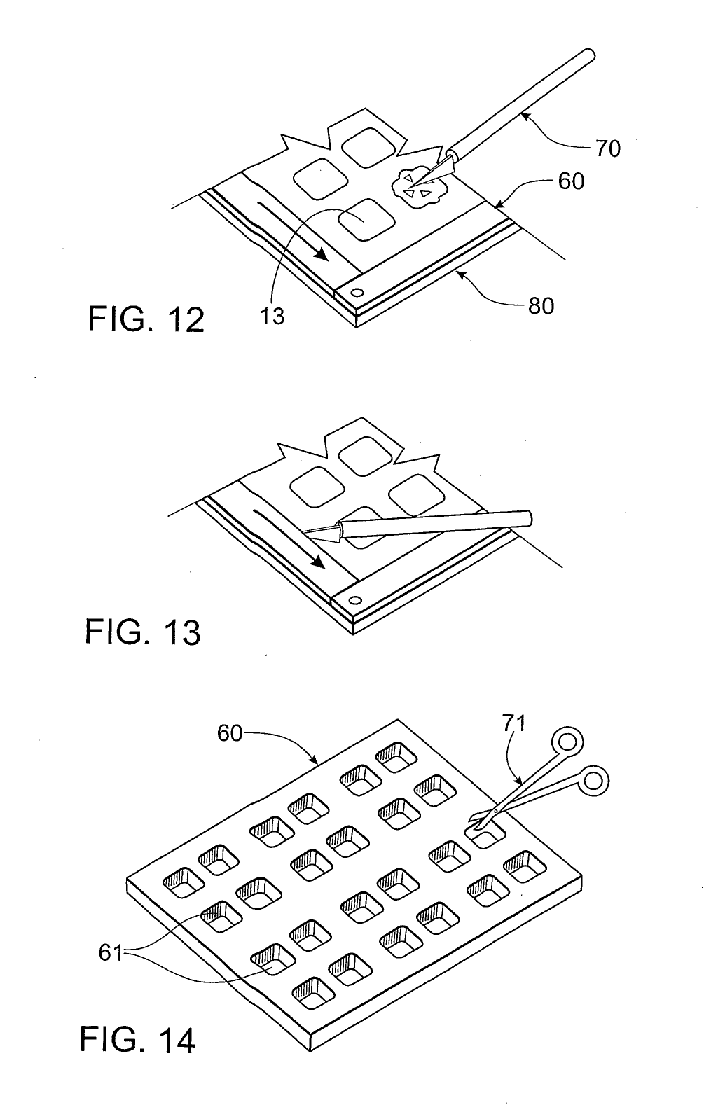

1. A flat bladed modelling knife 70 or safety edged razor blade is used to gently peel away excess cured rubber from the tops of the former shapes 13 before removing the mould plate 60 from the former 10. Care must be taken to avoid marking the new rubber mould plate 60 or the former 10, or scraping away the former shape material (FIG. 12).

2. Use the knife 70 to run around the sides of the rubber mould plate 60 to release it from the former 10 and trim the edges. Again, be careful not to cut into either the rubber mould plate 60 or the former 10 (FIG. 13).

3. A small pair of surgical curved scissors 71 with the sharp points rounded off is ideal for trimming all edges of the rubber mould plate 60 where necessary. (Although expensive, surgical grades have a better edge, last longer and have closer tolerances for this work) (FIG. 14).

Trimming takes some practice and good tools to minimise the risk of accidental rubber mould plate 60 damage, but it is not a difficult process.

Once the curing and trimming processes are completed, post curing must be carried out before the rubber mould plate 60 is suitable for use. There are two methods to achieve this:

1. The rubber mould plate 60 should sit for at least 7 days before use—longer if the weather is cold. Paper dividers must be placed under and between all of the new rubber mould plates 60 to prevent marking.

OR:

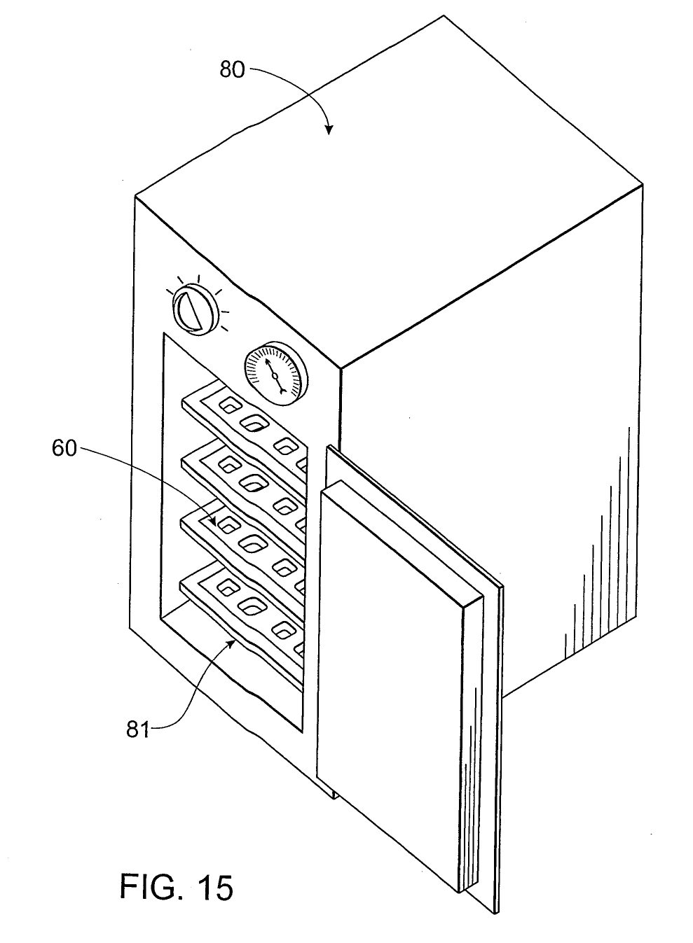

2. Place the rubber mould plates 60 in an oven 80 at 200° C. for two hours. The rubber mould(s) must be on a clean surface or tray 81 during this time. A layer of aluminium foil is preferably laid under the mould plate 60 to prevent contact with the metal tray (FIG. 15).

This process is essential to remove any carcinogens from the rubber.

After completion of the moulding process, cleaning of the bucket, mixers, press and work area is best done after 24 hours when the solution 34 has cured. At this time, the cured material will simply peel off.

Any cleaning of formers 10 is done with dry clean cloths or food grade detergents with thorough rinsing and drying.

No solvents should be used within the moulding area. Any such materials can contaminate the rubber mould plates 60 and risk contamination of the chocolate.

The hardener percentage and curing times will depend on the specific silicone rubber compound used—it must be of a suitable food grade.

III. Manufacture of the Chocolates
When the graphic plate and the rubber mould plate(s) 60 have been prepared, the chocolates can then be produced by the method disclosed in WO 97/39636, the drawings of which are included in the present specification by reference.
A thin layer of chocolate, of a first colour, is applied to the graphics (ie., first mould) plate to (preferably overfill) the images 17 engraved therein and any excess chocolate is removed, eg., by a scraper.
The mould plate 60 is accurately located on the graphics plate and secured thereto—at least by surface adhesion between the plates, with additional clamping applied if required.
The recesses 61 in the mould plate 60, accurately in register with the first colour chocolate design, are filled with a second colour chocolate.
The chocolate is allowed to set, eg., in a cooling tower or refrigerator before being released from the mould plate and graphics plate.
If preferred, the mould plate 60 may be trimmed to enable a coloured chocolate border, of the same or different colour, to be formed around the designs of the first chocolate colour.
The use of the former 10, with the former shapes 13 accurately located thereon by the template 20, ensures accurate register of the recesses 61 in the mould plate 60 with the engraved images 17 on the graphics (or first mould) plate.

With all the above processes, the computer system used for designing and engraving can be utilised in several ways:

1. A saving on design costs where compatible computerised systems are used for contracted machining or laser cutting.

2. By modifying the engraving program for the same graphics plate, the design of templates to assemble the former, or to manufacture former shapes, will be very accurate ensuring relativity of all components is maintained at each stage.

The present invention enables the accurate manufacture of the mould plates, and thereby manufacture of chocolates of high quality, where the thin raised designs are accurately located on the chocolates (with or without an optional border).

Various changes and modifications may be made to the embodiments described and illustrated without departing from the present invention.

1. A method of manufacturing a former for a mould plate for chocolate products including the steps of:
assembling a former plate, having a planar surface bounded by a border corresponding to the external dimensions of the mould plate;
producing a plurality of former shapes, corresponding to the recesses to be formed in the mould plate;
locating the former shapes in a template operable to locate the former shapes on the former plate;
applying adhesive to the former shapes; and
locating the former shapes on the former plate, using the template, to fix the former shapes to the former plate.

2. A method as claimed in claim 1 wherein:
the template has holes, operable to receive at least a portion of the former shapes, the holes being aligned with engraved or otherwise formed images on a graphics plate to which the mould plate is to be associated.

3. A method as claimed in claim 2 wherein:
the images on the graphics plate are formed by a laser engraver and are located thereon at spacings determined by a template layout programmed in computer software controls the laser engraver.

4. A method of manufacturing a mould plate for chocolate products including the steps of:
mixing a silicone rubber compound with a hardener to form a solution;
applying a vacuum to the solution to remove at least the majority of the air bubbles in the solution;
pouring a preset weight of the solution into a mould former, manufactured by the method of claim 1, and allowing the solution to settle;
applying a clamping pressure to the mould assembly and allowing the silicone rubber to at least initially cure; and
allowing the rubber to post cure before use.

5. A method as claimed in claim 4 wherein:
the solution is thoroughly mixed; and
a coloured hardener is used to see when mixing is complete.

6. A method as claimed in claim 4, wherein:
when the solution is poured into the mould former, filtered dry air is blown onto the surface of the solution to remove air bubbles on the surface and agitate and settle the solution around the shapes in the mould former.

7. A method as claimed in claim 4 wherein:
a flexible divider is applied to the top surface of the former and rolled with a roller to work any air pockets out of the solution and cause excess solution to be excluded from the former.

8. A method as claimed in claim 4 wherein:
the initial curing is for 24 hours.

9. A method as claimed in claim 4 wherein:
the edges of the mould plate are trimmed to remove any excess rubber, which has flowed onto an external top face of the former about the border of the mould surface.

10. A method as claimed in claim 4 wherein:
the post curing may be at room temperature for 7-10 days, or in a curing oven, at 200° C. for approximately 2 hours.

11. A method of manufacturing chocolates with a thin design of at least one other colour thereon, the method including the steps of:
engraving a plurality of images, corresponding to the design, on a graphics plate at preselected locations:
producing a mould plate former by assembling a former plate, having a planar surface bounded by a border corresponding to the external dimensions of the mould plate; producing a plurality of former shapes, corresponding to the recesses to be formed in the mould plate;
locating the former shapes in a template operable to locate the former shapes on the former plate; applying adhesive to the former shapes; and
locating the former shapes on the former plate, using the template, to fix the former shapes to the former plate; producing a rubber mould plate using the mould plate former by mixing a silicone rubber compound with a hardener to form a solution; applying a vacuum to the solution to remove at least the majority of the air bubbles in the solution; pouring a preset weight of the solution into a mould former, and allowing the solution to settle; applying a clamping pressure to the mould assembly and allowing the silicone rubber to at least initially cure; and allowing the rubber to post cure before use;
applying chocolate of at least a first colour to the graphics plate to fill the engraved image thereon, to form the design, and removing any excess chocolate;
locating the mould plate on the graphics plate with the recesses in the mould plate in register with the designs of the at least first colour chocolate;
filling the recesses with another colour chocolate;
allowing the chocolate to set; and
removing the final chocolates from the mould plate.

12. Chocolates with a thin design thereon made by the method of claim 11.

13. A method as claimed in claim 4 wherein:
the template has holes, operable to receive at least a portion of the former shapes, the holes being aligned with engraved or otherwise formed images on a graphics plate to which the mould plate is to be associated.

14. A method as claimed in claim 13 wherein:
the images on the graphics plate are formed by a laser engraver and are located thereon at spacings determined by a template layout programmed in computer software controls the laser engraver.

15. A method as claimed in claim 5 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.

16. A method as claimed in claim 6 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.

17. A method as claimed in claim 7 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.

18. A method as claimed in claim 8 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.

19. A method as claimed in claim 9 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.

20. A method as claimed in claim 10 wherein:
the template has holes, operable to receive at least a portion of the former shapes, the holes being aligned with engraved or otherwise formed images on a graphics plate to which the mould plate is to be associated, and
wherein the images on the graphics plate are formed by a laser engraver and are located thereon at spacings determined by a template layout programmed in computer software controls the laser engraver.
